(19) United States
(12) Patent Application Publication
(10) Pub. No.: US 2025/0369446 A1
(43) Pub. Date: Dec. 4, 2025

(54) BLOWER WITH IMPROVED FAN AND MOTOR DESIGN

(71) Applicant: Milwaukee Electric Tool Corporation, Brookfield, WI (US)

(72) Inventors: Brian D. Rothe, Hartland, WI (US); Luis F. Gonzalez Jauregui, Milwaukee, WI (US); Marcus T. Jenkins, Wauwatosa, WI (US); Christopher Shawn Bullington, Milwaukee, WI (US); Pranjal Kumar, Brookfield, WI (US); Harry T. Ward, Mequon, WI (US); Adam F. Czerwonka, Mukwonago, WI (US)

(21) Appl. No.: 19/212,932

(22) Filed: May 20, 2025

Related U.S. Application Data
(60) Provisional application No. 63/653,389, filed on May 30, 2024.
(60) Provisional application No. 63/761,328, filed on Feb. 21, 2025.

(51) Int. Cl. F04D 19/00; A01G 20/47; F04D 25/06; F04D 29/26; F04D 29/32; F04D 29/38

(52) U.S. Cl. CPC F04D 19/002; F04D 25/0646; F04D 29/263; F04D 29/329; F04D 29/388; A01G 20/47; F05D 2300/121; F05D 2300/43

(57) ABSTRACT

A fan and motor assembly for a blower is provided. The fan and motor assembly includes a fan extending between a first end and a second end opposite the first end, a rotor coupled to the fan, and a ring coupled to the second end of the fan and the rotor for securing the rotor to the fan. The fan includes a fan hub adjacent the first end and a plurality of blades adjacent the second end. The fan hub and the plurality of blades of the fan are integrally formed together. The fan at least partially surrounds the rotor.

### CROSS-REFERENCE TO RELATED APPLICATIONS

This application is a non-provisional application claiming the benefit of priority under 35 U.S.C. § 119(e) to U.S. Provisional Application No. 63/653,389, filed on May 30, 2024, and U.S. Provisional Application No. 63/761,328, filed on Feb. 21, 2025, both of which are hereby incorporated by reference in their entireties.

### FIELD

The present disclosure relates generally to blowers, and more particularly to blowers having improved fan and motor designs.

### BACKGROUND

Blowers are generally used to produce and output a stream of air to be directed by the user. Blowers are frequently utilized in outdoor applications, such as to blow leaves and other debris. Homeowners frequently utilized such blowers to clean their yards and outdoor spaces. The types of blowers can vary between backpack-style blowers and handheld blowers, as well as between gas-powered and electric blowers. Electric blowers can be corded and plugged into electrical outlets, or can be cordless and battery powered.

Some blowers include motors having a shaft extending along a length of the motor. Such a shaft arrangement adds rotating mass to the blower and can be costly to manufacture and assemble. The shaft may also be susceptible to deformation, which may create balance issues during operation of the motor.

Accordingly, improved blowers are desired in the art. In particular, blowers having improved fan and motor designs for reducing the rotating mass would be advantageous.

### BRIEF DESCRIPTION

Aspects and advantages of the present disclosure will be set forth in part in the following description, or may be obvious from the description, or may be learned through practice of the technology.

In accordance with one embodiment, a fan and motor assembly for a blower is provided. The fan and motor assembly includes a fan extending between a first end and a second end opposite the first end, a rotor coupled to the fan, and a ring coupled to the second end of the fan and the rotor for securing the rotor to the fan. The fan includes a fan hub adjacent the first end and a plurality of blades adjacent the second end. The fan hub and the plurality of blades of the fan are integrally formed together. The fan at least partially surrounds the rotor.

In accordance with another embodiment, a fan and motor assembly for a blower defining an axis of rotation is provided. The fan and motor assembly includes a fan hub extending between a first end and a second end and defining a central bore between the first end and the second end and an annular cavity circumscribing the central bore. The fan hub includes a divider wall between the central bore and the annular cavity, a first wall portion extending from the second end, and a second wall portion extending perpendicularly from the first wall portion. The first wall portion and the second wall portion define an annular flange circumscribing the second end and the second wall portion defines an annular recess. The fan and motor assembly also includes a fan coupled to the fan hub, a shaft coupled to the fan hub and extending between the first end and the second end along the axis of rotation, a stator mounted to the shaft, and a rotor coupled to the fan hub and at least partially surrounding the stator. An end of the fan is disposed in the annular recess, and an end of the rotor is disposed in the annular flange between an end portion of the fan and the first wall portion.

In accordance with yet another embodiment, a fan and motor assembly for a blower defining an axis of rotation is provided. The fan and motor assembly includes a fan hub extending between a first end and a second end along the rotational axis, a fan coupled to the fan hub adjacent the second end, and a dome attachment coupled to the fan hub adjacent the first end. The dome attachment includes a plurality of protrusions extending from an interior surface of the dome attachment and contacting an exterior surface of the fan hub such that a gap is defined between the dome attachment and the fan hub.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

The detailed description that follows makes reference to the appended figures, in which:

FIG. 1 is a perspective view of a blower in accordance with embodiments of the present disclosure;

FIG. 2 is a front, perspective view of a fan and motor assembly in accordance with embodiments of the present disclosure;

FIG. 3 is a rear, perspective view of the fan and motor assembly of FIG. 2 in accordance with embodiments of the present disclosure;

FIG. 4 is cross-sectional view of the fan and motor assembly of FIG. 2 in accordance with embodiments of the present disclosure;

FIG. 5 is a perspective view of a stator and a shaft of the fan and motor assembly of FIG. 2 in accordance with embodiments of the present disclosure;

FIG. 6 is a side view of the stator and the shaft of FIG. 5 in accordance with embodiments of the present disclosure;

FIG. 7 is a side view of a fan and motor assembly in accordance with embodiments of the present disclosure;

FIG. 8 is a cross-sectional view of the fan and motor assembly of FIG. 7 in accordance with embodiments of the present disclosure;

FIG. 9 is a perspective view of a fan and motor assembly in accordance with embodiments of the present disclosure;

FIG. 10 is a cross-sectional view of the fan and motor assembly of FIG. 9 in accordance with embodiments of the present disclosure;

FIG. 11 is a perspective view of a fan dome of the fan and motor assembly of FIG. 9 in accordance with embodiments of the present disclosure;

FIG. 12 is a cross-sectional view of the fan dome of FIG. 11 in accordance with embodiments of the present disclosure;

FIG. 13 is a detailed, end view of the fan dome of FIG. 11 in accordance with embodiments of the present disclosure;

FIG. 14 is a cross-sectional view of a fan and motor assembly in accordance with embodiments of the present disclosure;

FIG. 15 is a cross-sectional view of the fan and motor assembly of FIG. 14 within a blower housing in accordance with embodiments of the present disclosure;

FIG. 16 is a rear, perspective view of a fan assembly of the fan and motor assembly of FIG. 14 in accordance with embodiments of the present disclosure;

FIG. 17 is a rear, perspective view of the fan and motor assembly of FIG. 14 in accordance with embodiments of the present disclosure;

FIG. 18 is a perspective view of a motor assembly of the fan and motor assembly of FIG. 14 in accordance with embodiments of the present disclosure;

FIG. 19 is a cross-sectional view of a fan and motor assembly in accordance with embodiments of the present disclosure;

FIG. 20 is side view of a fan of the fan and motor assembly of FIG. 19 in accordance with embodiments of the present disclosure;

FIG. 21A is a perspective view of a dome attachment of the fan of FIG. 20 in accordance with embodiments of the present disclosure;

FIG. 21B is a perspective view of a dome attachment of the fan of FIG. 20 in accordance with embodiments of the present disclosure; and

FIG. 21C is a perspective view of a dome attachment of the fan of FIG. 20 in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising.” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

In general, fan and motor assemblies described herein reduce a rotating mass and improve balance of the assembly. For example, the fan and motor assemblies eliminate fasteners and a central shaft extending along a length of the fan and motor assembly. Additionally, the fan and motor assemblies described herein are durable and cost effective to manufacture and assemble.

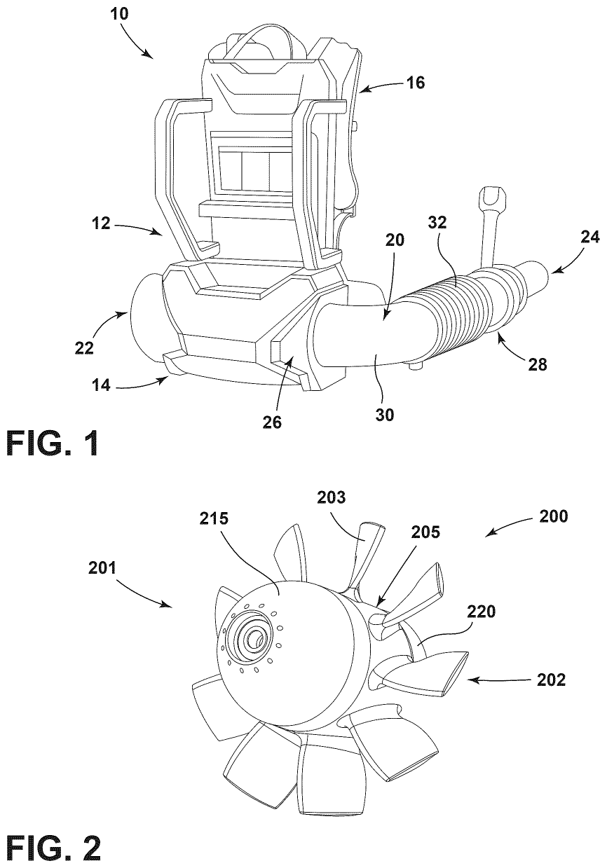

Referring now to the drawings, FIG. 1 illustrates a blower tool 10 having a main body 12 and a blower unit 14. While the blower tool 10 illustrated in FIG. 1 is a backpack blower configured to be worn on a user's back, e.g., with backpack supports 16, the features of the present invention may be implemented for a handheld blower (not illustrated), e.g., a handheld axial fan blower or a centrifugal fan blower.

In at least one example embodiment, the blower unit 14 includes an air duct 20 extending from an air inlet 22 to an air outlet 24. The air duct 20 may be formed by an air duct body 26 and a blower tube 28. For example, the air duct body 26 may define the air inlet 22 at one end thereof. The air duct body 26 may be coupled, directly or indirectly, with the blower tube 28 at an opposite end relative to the air inlet 22. For example, an elbow tube 30 may be provided between the air duct body 26 and the blower tube 28 as shown in FIG. 1. Alternatively, e.g., in a handheld blower (not shown), the air duct body 26 may be directly coupled to the blower tube 28. In some example embodiments, a bellows 32 may be provided between the air duct body 26 and the blower tube 28, e.g., to enable the blower tube 28 to pivotably move and/or rotate relative to the air duct body 26.

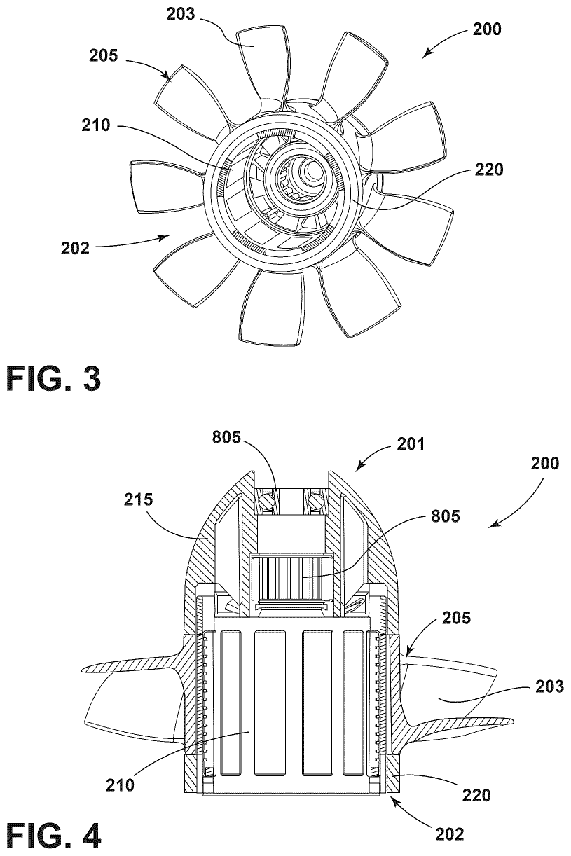

FIG. 2 illustrates a front, perspective view of a fan and motor assembly 200 in accordance with embodiments of the present disclosure. FIG. 3 illustrates a rear, perspective view of the fan and motor assembly 200 of FIG. 2 in accordance with embodiments of the present disclosure. FIG. 4 illustrates cross-sectional view of the fan and motor assembly 200 of FIG. 2 in accordance with embodiments of the present disclosure. In at least one example embodiment, the fan and motor assembly 200 may be disposed in the blower unit 14 (FIG. 1).

With reference to FIGS. 2-4, the fan and motor assembly 200 extends between a first end 201 and a second end 202. The fan and motor assembly 200 includes a fan 205 and a rotor 210 coupled to the fan 205. The rotor 210 is configured to translate rotational movement to the fan 205. The fan 205 includes a plurality of fan blades 203 and a fan hub 215. The fan hub 215 is adjacent the first end 201 and the plurality of fan blades 203 are adjacent the second end 202. The plurality of fan blades 203 and the fan hub 215 may be integrally formed together to form the fan 205. For example, the plurality of fan blades 203 and the fan hub 215 may be a single die-cast assembly forming a uniform body of the fan 205.

The rotor 210 is coupled to the fan 205 opposite the fan hub 215 and at least partially surrounded by the fan 205. More specifically, the rotor 210 is disposed in a receptacle defined by the fan 205. The fan 205 may be press-fit or over molded to an exterior of the rotor 210. Additionally, the fan 205 may be secured to the rotor 210 by a ring 220 coupled to the fan 205 and the rotor 210 adjacent the second end 202. In at least one example embodiment, the ring 220 comprises an aluminum material.

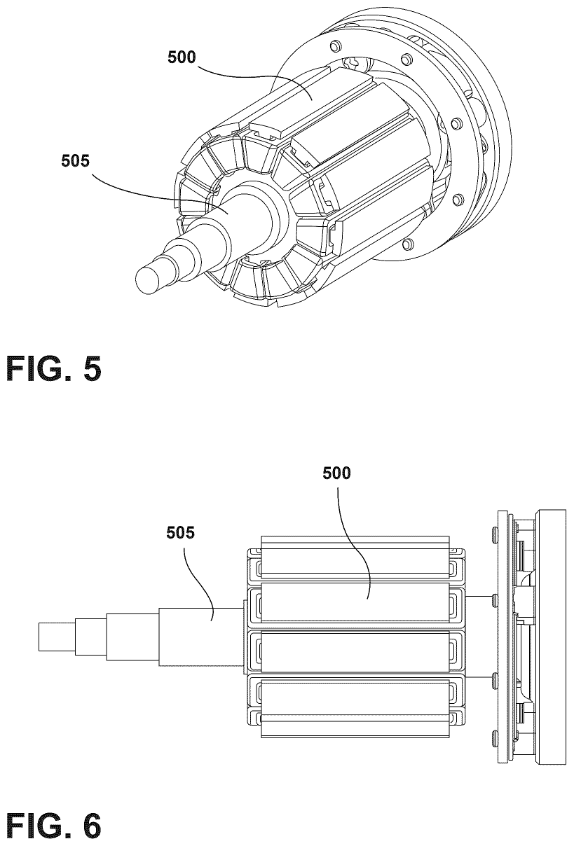

FIG. 5 illustrates a perspective view of a stator 500 and a shaft 505 of the fan and motor assembly 200 of FIG. 2 in accordance with embodiments of the present disclosure. FIG. 6 illustrates a side view of the stator 500 and the shaft 505 of FIG. 5 in accordance with embodiments of the present disclosure.

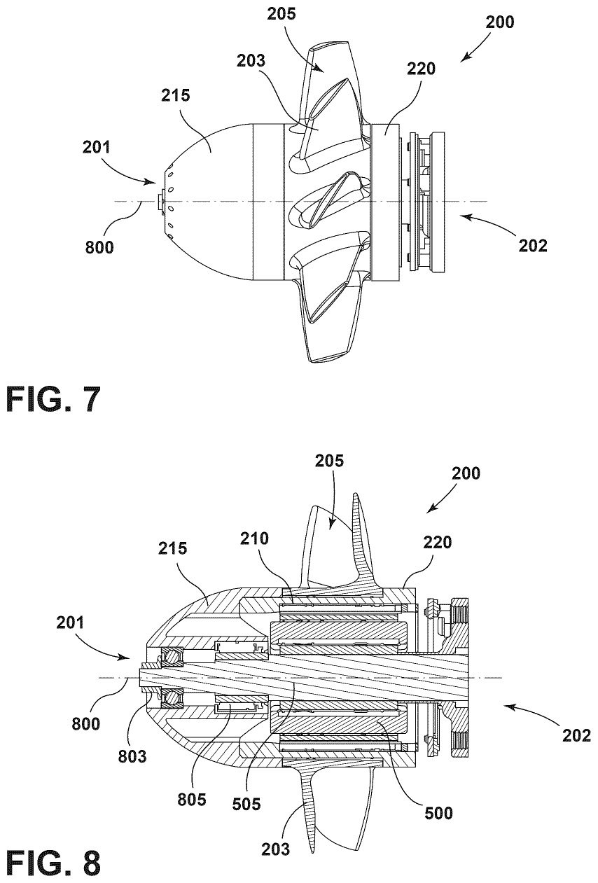

As shown in FIGS. 5-6, the stator 500 is mounted to the shaft 505. The shaft 505 may be a stationary shaft extending through the fan and motor assembly 200, as will be discussed below with respect to FIGS. 7-8.

FIG. 7 illustrates a side view of the fan and motor assembly 200 in accordance with embodiments of the present disclosure. FIG. 8 illustrates a cross-sectional view of the fan and motor assembly 200 of FIG. 7 in accordance with embodiments of the present disclosure.

With reference to FIG. 8, the rotor 210 is configured to receive the stator 500 such that the rotor 210 is mounted over the stator 500. The shaft 505 extends through the fan and motor assembly 200 from the first end 201 to the second end 202 along an axis of rotation 800 of the fan 205. For example, as shown in FIG. 8, the stator 500 at least partially surrounds or circumscribes the shaft 505, the rotor 210 at least partially surrounds or circumscribes the stator 500, and the fan 205 at least partially surrounds or circumscribes the rotor 210. In at least one example embodiment, the stator 500 is press fit onto the shaft 505 and the rotor 210 is press fit onto the stator 500.

Moreover, the shaft 505 extends through the stator 500, the rotor 210, the fan 205, and the fan hub 215 along the axis of rotation 800. The shaft 505 may be a stationary shaft. For example, one or more fasteners, such as a fastener 803, may secure the shaft 505 within the fan and motor assembly 200. As shown in FIG. 8, the fastener 803 may be a nut securing the shaft 505 to the fan hub 215. In other example embodiments, the one or more fasteners, including the fastener 803, may include one or more screws, bolts, or other suitable fasteners for securing the shaft 505 within the fan and motor assembly 200. In at least one example embodiment, the shaft 505 is formed of a material comprising aluminum. Moreover, the fan and motor assembly 200 may include one or more bearings 805 for supporting rotation of the rotor 210 and the fan 205 about the stator 500 and/or the shaft 505. The one or more bearings 805 may include a ball bearing, a needle bearing, or a combination thereof.

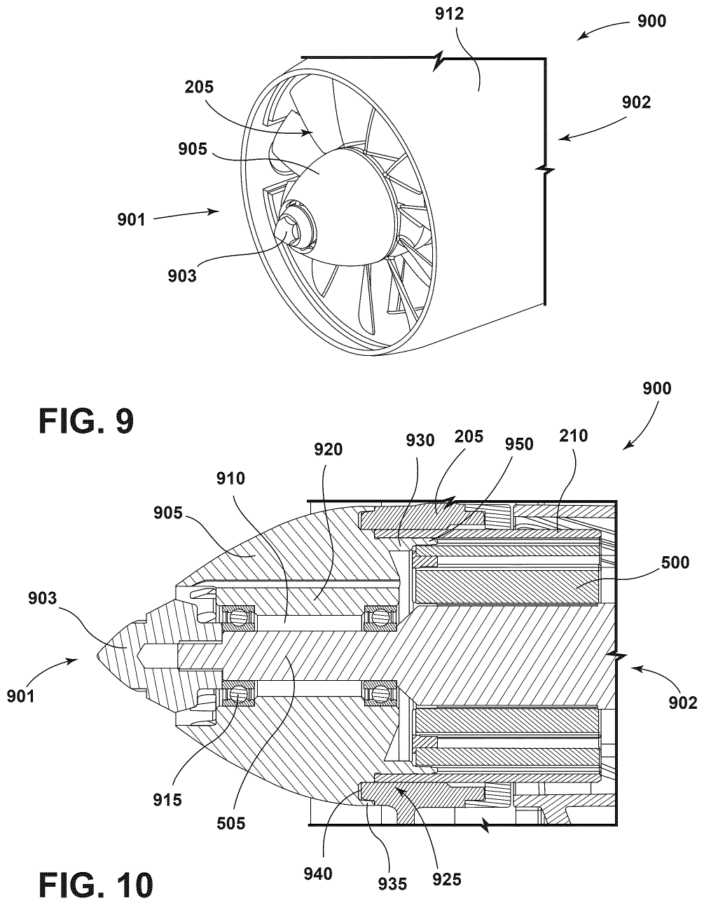

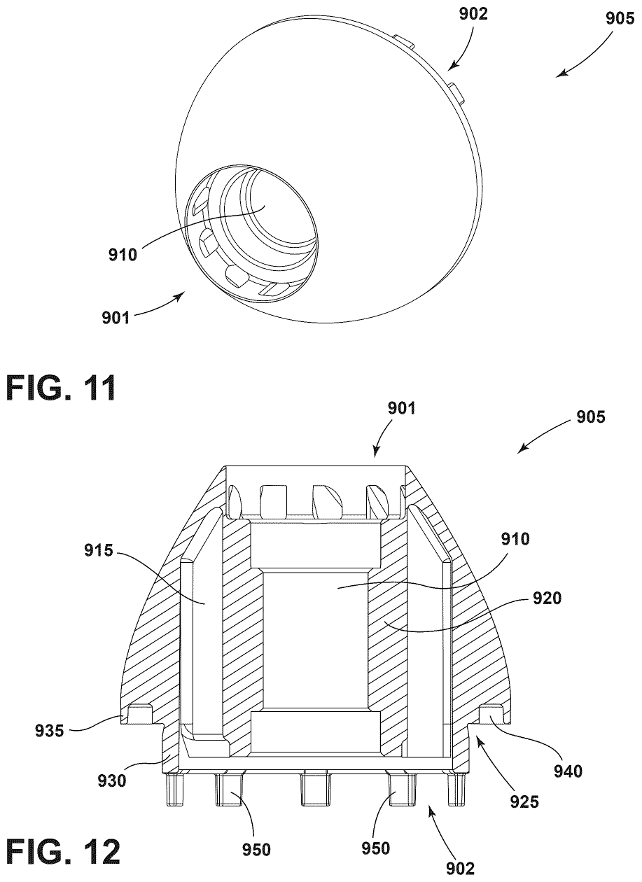

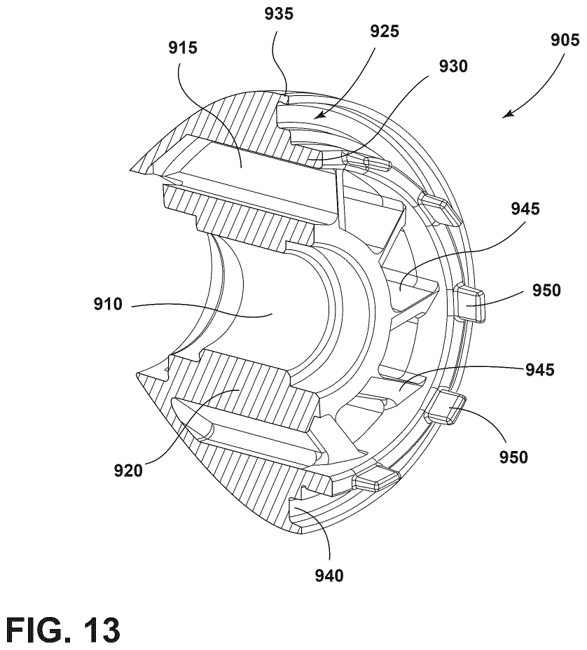

FIG. 9 illustrates a perspective view of a fan and motor assembly 900 in accordance with embodiments of the present disclosure. FIG. 10 illustrates a cross-sectional view of the fan and motor assembly 900 of FIG. 9 in accordance with embodiments of the present disclosure. FIG. 11 illustrates a perspective view of a fan hub 905 of the fan and motor assembly 900 of FIG. 9 in accordance with embodiments of the present disclosure. FIG. 12 illustrates a cross-sectional view of the fan hub 905 of FIG. 11 in accordance with embodiments of the present disclosure. FIG. 13 illustrates a detailed, end view of the fan hub 905 of FIG. 11 in accordance with embodiments of the present disclosure.

The fan and motor assembly 900 may be similar or analogous to the fan and motor assembly 200 discussed above with respect to FIGS. 2-8. More particularly, the fan and motor assembly 900 and/or the fan hub 905 may be incorporated into the blower unit 14 (FIG. 1) in place of the fan and motor assembly 200.

The fan and motor assembly 900 extends between a first end 901 and a second end 902. As shown in FIGS. 9-10, the fan and motor assembly 900 includes the fan 205, the rotor 210, the stator 500, and the shaft 505 discussed above with respect to FIGS. 2-8. Additionally, the fan and motor assembly 900 may include a shroud or housing 912. The housing 912 may have a generally cylindrical shape and may at least partially surround the fan 205.

In at least one example embodiment, the fan hub 905 has a general dome shape and defines a central bore 910 extending between the first end 901 and the second end 902. The central bore 910 may have a generally cylindrical shape. Moreover, as shown in FIG. 10, the central bore 910 may be configured to at least partially receive the shaft 505.

As shown in FIGS. 9-10, a fastener 903 may be configured to secure the fan hub 905 to the shaft 505. For example, the fastener 903 may be coupled to the first end 901 of the fan hub 905 and at least partially extend into the central bore 910. The fastener 903 may include a nut, bolt, screw, or other suitable fastener for securing the fan hub 905 to the shaft 505 of the fan and motor assembly 900.

With reference to FIGS. 12-13, the fan hub 905 may also define an annular cavity 915. The annular cavity 915 circumscribes the central bore 910. For example, a divider wall 920 may be disposed between the annular cavity 915 and the central bore 910. As shown in FIG. 13, a plurality of walls 945 may be disposed within the annular cavity 915. In at least one example embodiments, the plurality of walls 945 may be equally spaced about the circumference of the fan hub 905. In other example embodiments, the plurality of walls 945 may be unequally spaced about the circumference of the fan hub 905.

Still referring to FIGS. 12-13, the fan hub 905 includes a first wall portion 930 extending from the second end 902 and a second wall portion 935 extending perpendicularly to the first wall portion 930. The first wall portion 930 and the second wall portion define an annular flange 925 circumscribing the second end 902. For example, the annular flange 925 surrounds the annular cavity 915 and the central bore 910 at the second end 902. Additionally, the second wall portion 935 may define an annular recess 940 extending about a circumference of the fan hub 905.

As shown in FIG. 10, the annular flange 925 is configured to at least partially receive an end of the fan 205 and an end of the rotor 210. For example, the end of the fan 205 is disposed in the annular flange 925 and the annular recess 940, and the end of the rotor 210 is disposed in the annular flange 925. For example, the end of the rotor 210 is disposed in the annular flange 925 between the end of the fan 205 and the first wall portion 930.

Additionally, an interior surface of the second wall portion 935 may surround at least a portion of an exterior surface of the end of the fan 205. As shown in FIG. 10, an exterior surface of the second wall portion 935 and the exterior surface of the fan 205 may also be flush. Moreover, an exterior surface of the first wall portion 930 may engage at least a portion of an interior surface of the rotor 210.

Returning to FIGS. 12-13, a plurality of protrusions 950 may extend from the second end 902 of the fan hub 905. For example, the plurality of protrusions 950 may extend from the first wall portion 930 of the fan hub 905. As shown in FIG. 10, the plurality of protrusions 950 may at least partially engage an end of the stator 500. In at least one example embodiments, the plurality of protrusions 950 may be equally spaced about the circumference of the fan hub 905. In other example embodiments, the plurality of protrusions 950 may be unequally spaced about the circumference of the fan hub 905.

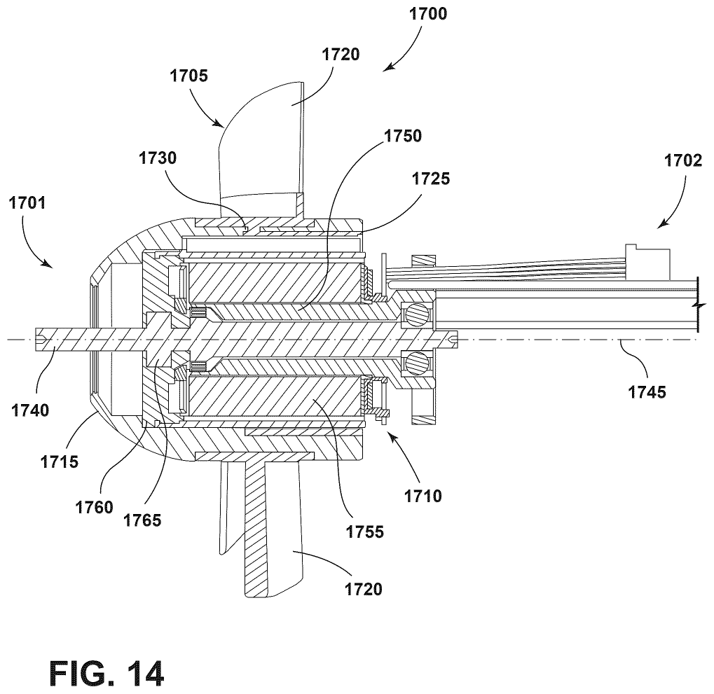

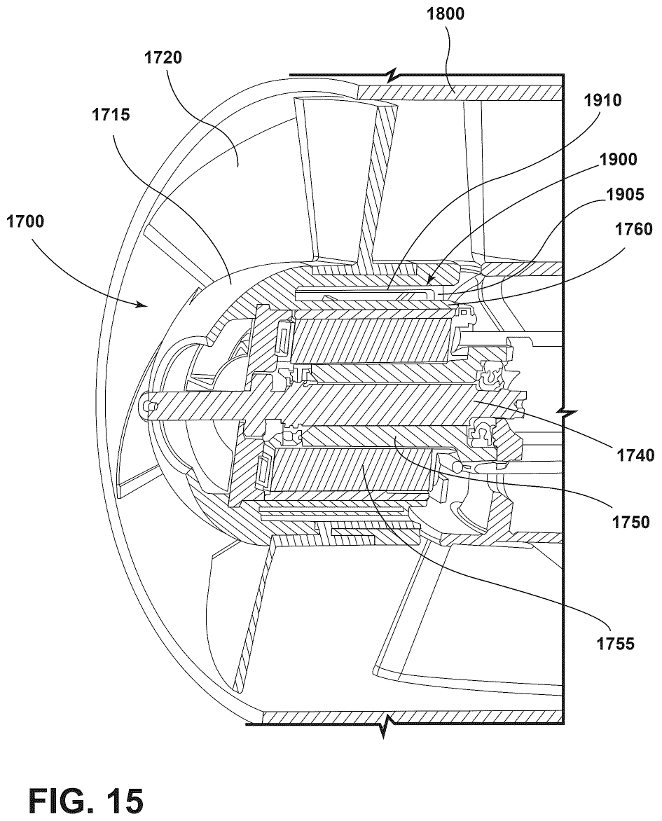

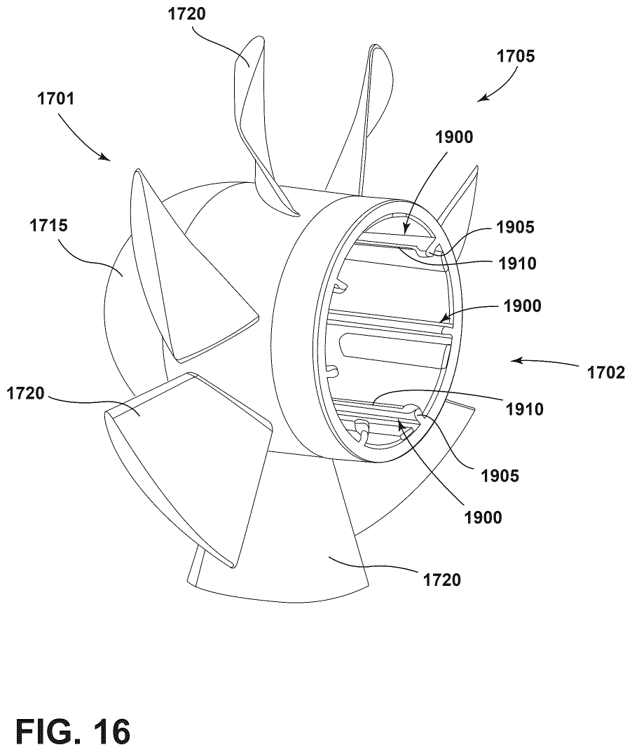

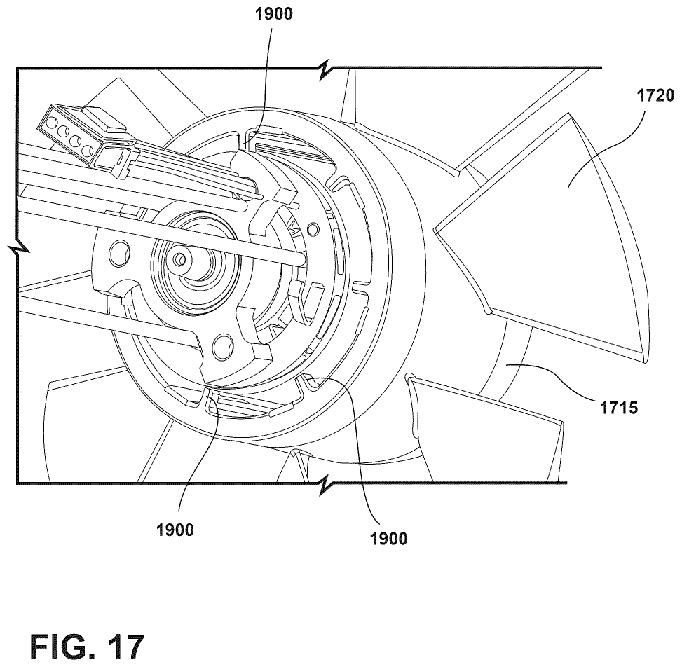

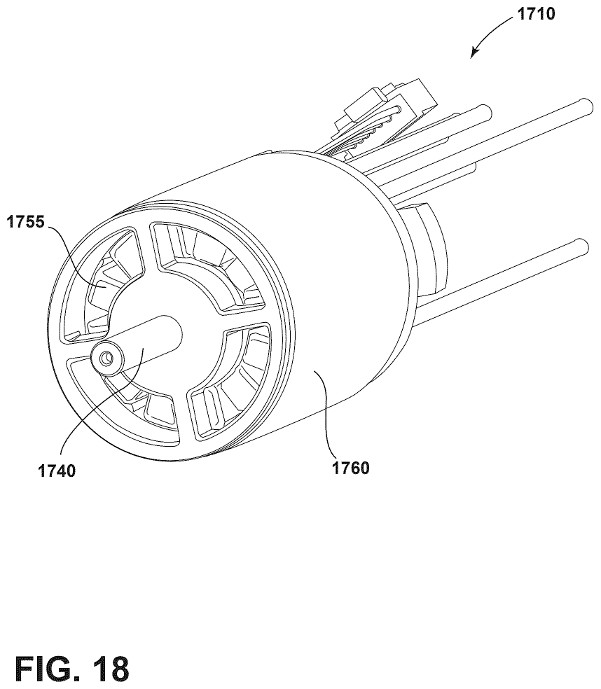

FIG. 14 illustrates a cross-sectional view of a fan and motor assembly 1700 in accordance with embodiments of the present disclosure. FIG. 15 illustrates a cross-sectional view of the fan and motor assembly 1700 of FIG. 14 within a blower housing 1800 in accordance with embodiments of the present disclosure. FIG. 16 illustrates a rear, perspective view of a fan assembly 1705 of the fan and motor assembly 1700 of FIG. 14 in accordance with embodiments of the present disclosure. FIG. 17 illustrates a rear, perspective view of the fan and motor assembly 1700 of FIG. 14 in accordance with embodiments of the present disclosure. FIG. 18 illustrates a perspective view of a motor assembly 1710 of the fan and motor assembly 1700 of FIG. 14 in accordance with embodiments of the present disclosure. The fan and motor assembly 1700 may be similar or analogous to the fan and motor assembly 200, 900 discussed above with respect to FIGS. 2-13.

The fan and motor assembly 1700 extends between a first end 1701 and a second end 1702 opposite the first end 1701. The fan and motor assembly 1700 includes a fan assembly 1705 and a motor assembly 1710. As shown in FIG. 15, the fan and motor assembly 1700 is disposed within the blower housing 1800. The blower housing 1800 may include a housing of the blower unit 14, shown in FIG. 1.

The fan assembly 1705 includes a fan hub 1715 and a plurality of fan blades 1720. In at least one example embodiment, the fan hub 1715 and the plurality of fan blades 1720 are integral. For example, the fan hub 1715 and the plurality of fan blades 1720 are a single, unitary component. In other example embodiments, the fan hub 1715 and the plurality of fan blades 1720 are separate components. In such embodiments, the fan hub 1715 and the plurality of fan blades 1720 may be formed of different materials. For example, the plurality of fan blades 1720 may be formed of a plastic material and the fan hub 1715 may be formed of an aluminum material. Moreover, the plastic material forming the plurality of fan blades 1720 may be over molded or injection molded about the fan hub 1715.

In such exemplary embodiments where the plurality of fan blades are over molded or injection molded over the fan hub 1715, the fan hub 1715 defines a groove 1725 and at least one through hole 1730. As shown in FIG. 14, an inner surface of the fan hub defines the groove 1725 extending from the second end 1702 towards the first end 1701. The groove 1725 may extend at least partially about a circumference of the fan hub 1715. The at least one through hole 1730 extends from the interior surface of the fan hub 1715 to an exterior surface of the fan hub 1715 and extends perpendicular to the groove 1725. The at least one through hole 1730 is in communication with the groove 1725 such that the through hole 1730 and the groove 1725 provide a channel for the plastic material to flow when forming the plurality of fan blades 1720 during the over mold or injection mold process. Accordingly, the plurality of fan blades 1720 may include plastic material extending within the at least one through hole 1730 and the groove 1725 for securing and retaining the plurality of fan blades 1720 to the fan hub 1715.

The motor assembly 1710 includes a shaft 1740 extending along a longitudinal axis 1745 extending between the first end 1701 and the second end 1702. The motor assembly 1710 also include a bearing housing including one or more bearings 1750, a stator 1755, and a rotor 1760. The motor assembly 1710 is coupled to the fan hub 1715 by a press fit between the fan hub 1715 and at least one of a fan hub bushing 1765 and the stator 1755. Moreover, in some example embodiments, each of the plurality of fan blades 1720 are positioned between adjacent ones of the one or more bearings 1750.

In at least one example embodiment, the bearing 1750 and the stator 1755 are separate components. In other example embodiments, the bearing 1750 and the stator 1755 may be integral. In additional example embodiments, the stator 1755 is a segmented stator with the bearing 1750 being a separate component from the stator 1755. As shown in FIGS. 14-15, the stator 1755 circumscribes the bearing 1750. The bearing 1750 and the stator 1755 are stationary. The rotor 1760 is disposed about the stator 1755 and configured to rotate in a circumferential direction about the stator 1755.

The shaft 1740 is configured to receive and couple components of the fan and motor assembly 1700 using a press fit. For example, the press fit coupling of components of the fan and motor assembly 1700 along the shaft 1740 removes the need for washers and fasteners, which reduces vibrations and simplifies dynamic balancing of the fan and motor assembly 1700. For example, the fan and motor assembly 1700 is balanced as a unit where the correction planes for balancing the fan and motor assembly 1700 are about or between the bearing 1750. The fan and motor assembly 1700 is also balanced by removing material from the fan hub 1715. In such exemplary embodiments, it is beneficial for the fan hub 1715 to at least partially be formed of a non-ferrous material such that debris resulting from removing fan hub material is not captured about the motor assembly 1710 due to a magnetic field of the rotor 1760.

With reference to FIGS. 16-17, a plurality of ribs 1600 extend from and are disposed about the interior surface of the fan hub 1715. The plurality of ribs 1600 are equidistantly spaced in the circumferential direction about the longitudinal axis 1745. In other example embodiments, the plurality of ribs 1600 may be unequally spaced about the longitudinal axis 1745.

The plurality of ribs 1600 are configured to aid with alignment of the motor assembly 1710 within the fan hub 1715. Each of the plurality of ribs 1600 include an end portion 1605 adjacent the second end 1702 and an elongated portion 1610 extending from the end portion 1605 towards the first end 1901. The end portion 1605 may protrude from the interior surface of the fan hub 1715 past the elongated portion 1610. Accordingly, the end portion 1605 is configured to contact an exterior surface of the rotor 1760, as shown in FIG. 15, for aligning the motor assembly 1710 within the fan hub 1715. Moreover, the plurality of ribs 1600 are configured to center the motor assembly 1710 within the fan hub 1715 about an axis of rotation of the bearing 1750 and/or the shaft 1740, such as about the longitudinal axis 1745 (FIG. 14). Such alignment ensures that the fan and motor assembly 1700 is dynamically balanced.

In at least one example embodiment, at least one opening is disposed in the fan hub bushing 1765 of the fan assembly 1705. With reference to FIG. 1, the at least one opening is in fluid communication between the air inlet 22 to the air outlet 24 of the blower unit 14. The at least one opening is configured to receive at least a portion of airflow flowing from the air outlet 24 and direct the airflow to the air inlet 22 during operation of the blower tool 10. Such redirection of airflow from the air outlet 24 to the air inlet 22 by the at least one opening aids in cooling the motor assembly 1710, resulting in a cooling airflow.

In at least one example embodiment, the fan assembly 1705 further includes secondary fan blades disposed about the fan hub bushing 1765. The secondary fan blades are configured to rotate and aid the cooling airflow for cooling the motor assembly 1710. The secondary fan blades may be integral with the fan hub bushing 1765 in some example embodiments.

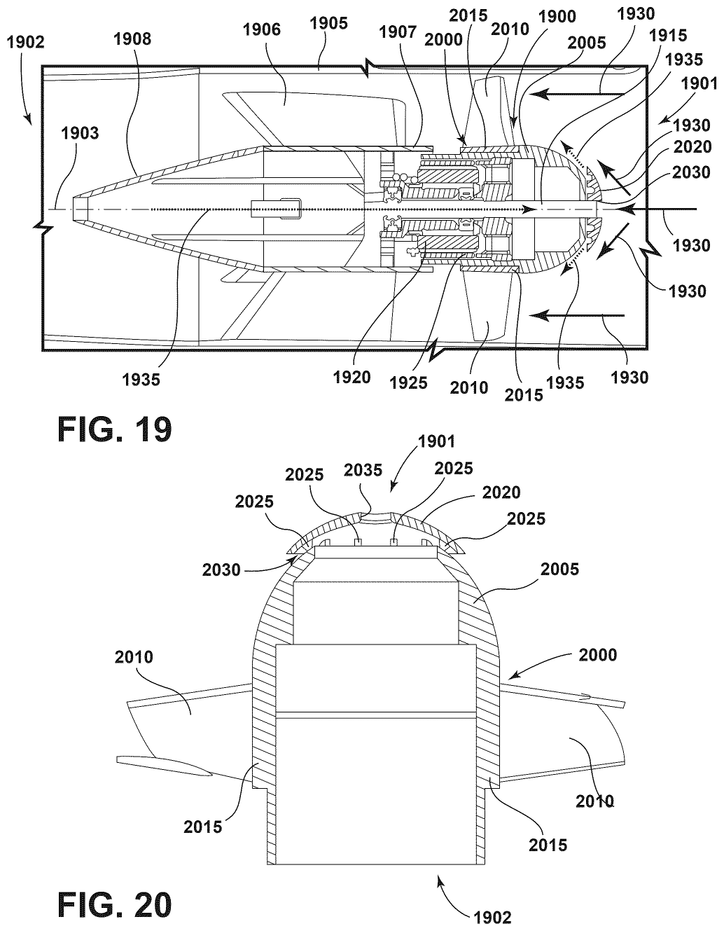

FIG. 19 illustrates a cross-sectional view of blower housing 1905 including a fan and motor assembly 1900 in accordance with embodiments of the present disclosure. The fan and motor assembly 1900 may be similar or analogous to the fan and motor assembly 200, 900, 1700 discussed above with respect to FIGS. 2-18. The blower housing 1905 may include a housing of the blower unit 14, shown in FIG. 1.

The blower housing 1905 extends between a first end 1901 and a second end 1902 opposite the first end 1901. The fan and motor assembly 1900 may be disposed within the blower housing 1905 adjacent the first end 1901. In at least one example embodiments, a plurality of stator blades 1906 for directing airflow generated by the fan and motor assembly 1900 are disposed in the blower housing 1905. Each of the plurality of stator blades 1906 extend from a base 1907. A cone portion 1908 is also disposed in the blower housing 1905 adjacent the second end 1902. Accordingly, the fan and motor assembly 1900, the plurality of stator blades 1906, and the cone portion 1908 are disposed in the blower housing 1905 in serial order from the first end 1901 to the second end 1902. Moreover, the base 1907 of the plurality of stator blades 1906 is coupled between an end of the fan and motor assembly 1900 and an end of the cone portion 1908.

The fan and motor assembly 1900 includes a fan 2000. The fan and motor assembly 1900 also includes a shaft 1915 extending along a rotational axis 1903 between the first end 1901 and the second end 1902, a stator 1920 coupled to the shaft 1915, and a rotor 1925 coupled to and at least partially surrounding the stator 1920. The fan 2000 is coupled to the rotor 1925 and at least partially surrounds the shaft 1915, the stator 1920, and the rotor 1925.

FIG. 20 illustrates side view of a fan 2000 and a fan hub 2005 of the fan and motor assembly 1900 of FIG. 19 in accordance with embodiments of the present disclosure. As shown in FIGS. 19-20, the fan 2000 includes a plurality of fan blades 2010 coupled to the fan hub 2005. For example, the fan 2000 may include one or more blade base 2015 from which each of the plurality of fan blades 2010 extend coupled to an exterior of the fan hub 2005. Moreover, an exterior surface of the one or more blade bases 2015 may be flush with at least a portion of the exterior surface of the fan hub 2005.

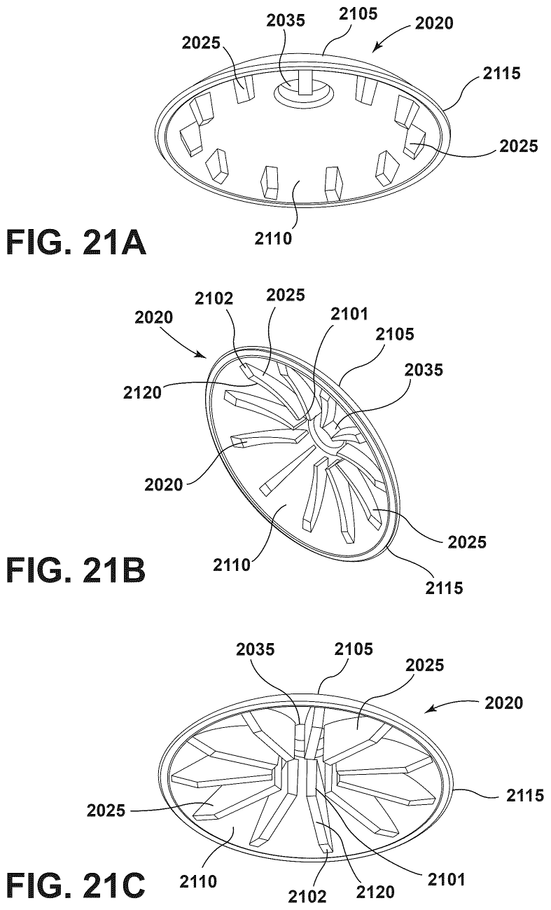

With reference to FIGS. 19-20, a dome attachment 2020 is coupled to an end of the fan hub 2005 at the first end 1901. The dome attachment 2020 includes a plurality of protrusions 2025 extending from an inner surface of the dome attachment 2020, as will be discussed in greater detail with respect to FIGS. 21A-21C. The plurality of protrusions 2025 contact the end of the fan hub 2005 such that a gap 2030 is defined between the dome attachment 2020 and the fan hub 2005.

In at least one example embodiment, the dome attachment 2020 defines a central opening 2035. The central opening 2035 may receive a fastener for securing the dome attachment 2020 to the fan hub 2005 and/or the shaft 1915. In other example embodiments, the dome attachment 2020 has no central opening 2035 and the dome attachment 2020 may be coupled to the fan hub 2005 and/or the shaft 1915 without the use of a fastener, such as by a press-fit.

Referring again to FIG. 19, rotation of the fan 2000 generates a first airflow 1930 flowing from the first end 1901 to the second end 1902. For example, the first airflow 1930 flows from the first end 1901 and through the fan blades 2010 and the stator blades 1906 to the second end 1902. Rotation of the fan 2000 also induced a second airflow 1935 flowing from the second end 1902 to the first end 1901 for cooling the fan and motor assembly 1900. The second airflow 1935 flows through a fluid passageway defined by the cone portion 1908, the base 1907, and an interior of the fan and motor assembly 1900. The second airflow 1935 also flows out of the fan and motor assembly 1900 through the gap 2030 defined between the fan hub 2005 and the dome attachment 2020 and joins the first airflow 1930 within the blower housing 1905.

FIG. 21A illustrates a perspective view of a dome attachment of the fan of FIG. 20 in accordance with embodiments of the present disclosure. FIG. 21B illustrates a perspective view of a dome attachment of the fan of FIG. 20 in accordance with embodiments of the present disclosure. FIG. 21C illustrates a perspective view of a dome attachment of the fan of FIG. 20 in accordance with embodiments of the present disclosure.

The dome attachment 2020 includes an outer surface 2105 and an inner surface 2110 opposite the outer surface 2105 extending from the central opening 2035 to an outer perimeter 2115. Additionally, as shown in FIGS. 21A-21C, the dome attachment 2020 has a dome shape.

With reference to FIG. 21A, the plurality of protrusions 2025 extend from the inner surface 2110 adjacent the outer perimeter 2115. For example, each of the plurality of protrusions 2025 may be closer to the outer perimeter 2115 than the central opening 2035. In at least one example embodiment, as shown in FIG. 21A, each of the plurality of protrusions 2025 may have a generally rectangular shape. In other example embodiments, each of the plurality of protrusions 2025 may have a triangular or other polygonal shape.

With reference to FIGS. 21B and 21C, the plurality of protrusions 2025 may have an elongated shape extending from a first end 2101 adjacent the central opening 2035 to a second end 2102 adjacent the outer perimeter 2115 in some example embodiments. Accordingly, the plurality of protrusions 2025 may form a plurality of dome blades for forming a centrifugal fan for directing the second airflow 1935 through the gap 2030, as shown in FIG. 19.

Still referring to FIGS. 21B and 21C, the plurality of protrusions include an outer surface 2120 extending between the first end 2101 and the second end 2102. As shown in FIG. 21B, the outer surface 2120 may define a substantially curved shape, as shown in FIG. 21C, and/or the outer surface 2120 may define a substantially linear shape, as shown in FIG. 21C.

Further aspects of the disclosure are provided by one or more of the following embodiments:

A fan and motor assembly for a blower, comprising: a fan extending between a first end and a second end opposite the first end, the fan comprising a fan hub adjacent the first end and a plurality of blades adjacent the second end, wherein the fan hub and the plurality of blades of the fan are integrally formed together; a rotor coupled to the fan, the fan at least partially surrounding the rotor; and a ring coupled to the second end of the fan and the rotor for securing the rotor to the fan.

The fan and motor assembly of any one or more of the embodiments, further comprising: a shaft coupled to the fan and extending along a rotational axis of the fan; and a stator coupled to and at least partially surrounding the shaft.

The fan and motor assembly of any one or more of the embodiments, wherein the stator is press fit onto the shaft.

The fan and motor assembly of any one or more of the embodiments, wherein the shaft is a stationary shaft coupled to the fan.

The fan and motor assembly of any one or more of the embodiments, further comprising a fastener for securing the shaft to the fan hub.

The fan and motor assembly of any one or more of the embodiments, wherein the fan hub and the plurality of blades are die-cast to form a uniform body of the fan.

The fan and motor assembly of any one or more of the embodiments, wherein fan is press-fit or over molded to the rotor.

The fan and motor assembly of any one or more of the embodiments, wherein the plurality of blades are over molded or injection molded about the fan hub.

The fan and motor assembly of any one or more of the embodiments, wherein the plurality of blades comprise a plastic material and the fan hub comprises an aluminum material.

The fan and motor assembly of any one or more of the embodiments, wherein the fan hub defines a groove extending at least partially about a circumference of the fan hub and at least one through hole extending from an interior surface of the fan hub to an exterior surface of the fan hub, the at least one through hole in communication with the groove, and wherein at least a portion of each of the plurality of blades extend through the at least one through hole and the groove securing the plurality of blades to the fan hub.

The fan and motor assembly of any one or more of the embodiments, wherein the fan hub comprises a plurality of ribs extending from and disposed about an interior surface of the fan hub.

The fan and motor assembly of any one or more of the embodiments, wherein each of the plurality of ribs comprise an end portion adjacent the second end and an elongated portion extending from the end portion towards the first end, and wherein the end portion protrudes past the elongated portion.

The fan and motor assembly of any one or more of the embodiments, further comprising: a shaft coupled to the fan and extending along a rotational axis of the fan; and a stator coupled to and at least partially surrounding the shaft; wherein the end portion of each of the plurality of ribs contacts an exterior surface of the rotor such that the rotor, the stator, and the shaft are centered about an axis of rotation.

A fan and motor assembly for a blower defining an axis of rotation, the fan and motor assembly comprising: a fan hub extending between a first end and a second end, the fan hub defining a central bore between the first end and the second end and an annular cavity circumscribing the central bore, wherein the fan hub comprises: a divider wall between the central bore and the annular cavity, a first wall portion extending from the second end, and a second wall portion extending perpendicularly from the first wall portion, wherein the first wall portion and the second wall portion define an annular flange circumscribing the second end, and wherein second wall portion defines an annular recess; a fan coupled to the fan hub, an end of the fan disposed in the annular recess; a shaft coupled to the fan hub and extending between the first end and the second end along the axis of rotation; a stator mounted to the shaft; and a rotor coupled to the fan hub and at least partially surrounding the stator, an end of the rotor disposed in the annular flange between an end portion of the fan and the first wall portion.

The fan and motor assembly of any one or more of the embodiments, further comprising a housing at least partially surrounding the fan.

The fan and motor assembly of any one or more of the embodiments, wherein the fan hub further comprises a plurality of protrusions extending from the second end, the plurality of protrusions coupled to an end of the stator.

The fan and motor assembly of any one or more of the embodiments, wherein: the plurality of protrusions extend from the first wall portion; and the plurality of protrusions are equally spaced about a circumference of the fan hub.

The fan and motor assembly of any one or more of the embodiments, further comprising a fastener extending through the central bore at the first end and securing the fan hub to the shaft.

A fan and motor assembly for a blower defining a rotational axis, the fan and motor assembly comprising: a fan hub extending between a first end and a second end along the rotational axis; a fan coupled to the fan hub adjacent the second end; and a dome attachment coupled to the fan hub adjacent the first end, the dome attachment comprising a plurality of protrusions extending from an interior surface of the dome attachment and contacting an exterior surface of the fan hub such that a gap is defined between the dome attachment and the fan hub.

The fan and motor assembly of any one or more of the embodiments, wherein the dome attachment is configured to direct a flow of air radially outward through the gap.

The fan and motor assembly of any one or more of the embodiments, wherein the dome attachment is removably couplable to the fan hub.

The fan and motor assembly of any one or more of the embodiments, wherein the plurality of protrusions comprise a plurality of dome blades, each of the plurality of dome blades extending radially outward from a center of the dome attachment towards an outer perimeter of the dome attachment.

The fan and motor assembly of any one or more of the embodiments, wherein the plurality of dome blades are configured to induce a flow of air radially outward through the gap.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fan and motor assembly for a blower, comprising:
a fan extending between a first end and a second end opposite the first end, the fan comprising a fan hub adjacent the first end and a plurality of blades adjacent the second end, wherein the fan hub and the plurality of blades of the fan are integrally formed together;
a rotor coupled to the fan, the fan at least partially surrounding the rotor; and
a ring coupled to the second end of the fan and the rotor for securing the rotor to the fan.

2. The fan and motor assembly of claim 1, further comprising:
a shaft coupled to the fan and extending along a rotational axis of the fan; and
a stator coupled to and at least partially surrounding the shaft.

3. The fan and motor assembly of claim 2, wherein the stator is press fit onto the shaft.

4. The fan and motor assembly of claim 2, wherein the shaft is a stationary shaft coupled to the fan; and wherein the fan and motor assembly further comprises a fastener for securing the shaft to the fan hub.

5. The fan and motor assembly of claim 1, wherein the fan hub and the plurality of blades are die-cast to form a uniform body of the fan.

6. The fan and motor assembly of claim 1, wherein fan is press-fit or over molded to the rotor.

7. The fan and motor assembly of claim 1, wherein the plurality of blades are over molded or injection molded about the fan hub.

8. The fan and motor assembly of claim 7, wherein the plurality of blades comprise a plastic material and the fan hub comprises an aluminum material.

9. The fan and motor assembly of claim 7, wherein the fan hub defines a groove extending at least partially about a circumference of the fan hub and at least one through hole extending from an interior surface of the fan hub to an exterior surface of the fan hub, the at least one through hole in communication with the groove, and wherein at least a portion of each of the plurality of blades extend through the at least one through hole and the groove securing the plurality of blades to the fan hub.

10. The fan and motor assembly of claim 7, wherein:
the fan hub comprises a plurality of ribs extending from and disposed about an interior surface of the fan hub; and
each of the plurality of ribs comprise an end portion adjacent the second end and an elongated portion extending from the end portion towards the first end, and wherein the end portion protrudes past the elongated portion.

11. The fan and motor assembly of claim 10, further comprising:
a shaft coupled to the fan and extending along a rotational axis of the fan; and
a stator coupled to and at least partially surrounding the shaft;
wherein the end portion of each of the plurality of ribs contacts an exterior surface of the rotor such that the rotor, the stator, and the shaft are centered about an axis of rotation.

12. A fan and motor assembly for a blower defining an axis of rotation, the fan and motor assembly comprising:
a fan hub extending between a first end and a second end, the fan hub defining a central bore between the first end and the second end and an annular cavity circumscribing the central bore, wherein the fan hub comprises:
a divider wall between the central bore and the annular cavity,
a first wall portion extending from the second end, and
a second wall portion extending perpendicularly from the first wall portion, wherein the first wall portion and the second wall portion define an annular flange circumscribing the second end, and wherein second wall portion defines an annular recess;
a fan coupled to the fan hub, an end of the fan disposed in the annular recess;
a shaft coupled to the fan hub and extending between the first end and the second end along the axis of rotation;
a stator mounted to the shaft; and
a rotor coupled to the fan hub and at least partially surrounding the stator, an end of the rotor disposed in the annular flange between an end portion of the fan and the first wall portion.

13. The fan and motor assembly of claim 12, further comprising a housing at least partially surrounding the fan.

14. The fan and motor assembly of claim 12, wherein the fan hub further comprises a plurality of protrusions extending from the second end, the plurality of protrusions coupled to an end of the stator.

15. The fan and motor assembly of claim 14, wherein:
the plurality of protrusions extend from the first wall portion; and
the plurality of protrusions are equally spaced about a circumference of the fan hub.

16. The fan and motor assembly of claim 12, further comprising a fastener extending through the central bore at the first end and securing the fan hub to the shaft.

17. A fan and motor assembly for a blower defining a rotational axis, the fan and motor assembly comprising:
a fan hub extending between a first end and a second end along the rotational axis;
a fan coupled to the fan hub adjacent the second end; and
a dome attachment coupled to the fan hub adjacent the first end, the dome attachment comprising a plurality of protrusions extending from an interior surface of the dome attachment and contacting an exterior surface of the fan hub such that a gap is defined between the dome attachment and the fan hub.

18. The fan and motor assembly of claim 17, wherein the dome attachment is configured to direct a flow of air radially outward through the gap.

19. The fan and motor assembly of claim 17, wherein the dome attachment is removably couplable to the fan hub.

20. The fan and motor assembly of claim 17, wherein the plurality of protrusions comprise a plurality of dome blades, each of the plurality of dome blades extending radially outward from a center of the dome attachment towards an outer perimeter of the dome attachment; and wherein the plurality of dome blades are configured to induce a flow of air radially outward through the gap.
